(19) United States
(12) Patent Application Publication
(10) Pub. No.: US 2025/0113412 A1
(43) Pub. Date: Apr. 3, 2025

(54) TRANSPARENT HEATING STRUCTURE TRANSMITTING COMMUNICATION FREQUENCY BAND

(71) Applicants: KOREA INSTITUTE OF MACHINERY & MATERIALS, Daejeon (KR); CENTER FOR ADVANCED META-MATERIALS, Daejeon (KR)

(72) Inventors: Hyeon Don KIM, Daejeon (KR); Jae Hyun KIM, Daejeon (KR); Bong Kyun JANG, Daejeon (KR); Mi Kyung LIM, Daejeon (KR); Hak Joo LEE, Daejeon (KR); Lee Kyo JEONG, Daejeon (KR)

(21) Appl. No.: 18/687,897

(22) PCT Filed: Dec. 12, 2022
(86) PCT No.: PCT/KR2022/020169

§ 371 Date: Nov. 4, 2024

(30) Foreign Application Priority Data
Dec. 13, 2021 (KR) 10-2021-0177684

(51) Int. Cl. H05B 3/84

(52) U.S. Cl. CPC H05B 3/84

(57) ABSTRACT

A transparent heating structure includes a substrate and a pattern portion. The substrate is transparent to visible light. The pattern portion is disposed on the substrate, and is configured to transmit communication frequency bands and to be heated. The pattern portion has a plurality of cells disposed on the substrate, and each of the cells has a plurality of unit grids having a slot.

### BACKGROUND

### Field of Disclosure

The present disclosure of invention relates to a transparent heating structure, and more specifically the present disclosure of invention relates to a transparent heating structure configured to transmit 5G communication frequency bands, to have high transmittance at visible light band and to be heated.

### DESCRIPTION OF RELATED TECHNOLOGY

These days, vehicles go beyond simply transporting goods and personnel and commonly include audio and video devices so that drivers can listen to music and watch videos while driving. In addition, in the vehicles, navigation devices that display the route to the driver's destination are also being widely installed.

Recently, the technological shift from internal combustion engine vehicles to electric vehicles has occurred rapidly, and the need for vehicles to communicate with external devices or external vehicles is also increasing.

5G communication technologies, with a maximum speed of 20 Gbps, can implement virtual reality, autonomous driving, and Internet of Things technologies through ultra-low latency and hyper-connectivity. Thus, attempts are underway to apply the 5G communication technology to vehicle-to-vehicle communication. For example, OTA (Over The Air) technology through 5G high-speed communication is in the spotlight.

However, if there are metal wires or transparent electrodes for heating glass to remove fogging or frost, there is a problem that 5G communication electromagnetic waves cannot penetrate.

### SUMMARY

The present invention is developed to solve the above-mentioned problems of the related arts. The present invention provides a transparent heating structure configured to transmit 5G communication frequency bands, to have high transmittance at visible light band and to be heated.

It is understood that the present invention should not be limited to these exemplary embodiments but various changes and modifications can be made by one ordinary skilled in the art within the spirit and scope of the present invention as hereinafter claimed.

According to an example embodiment, a transparent heating structure includes a substrate and a pattern portion. The substrate is transparent to visible light. The pattern portion is disposed on the substrate, and is configured to transmit communication frequency bands and to be heated. The pattern portion has a plurality of cells disposed on the substrate, and each of the cells has a plurality of unit grids having a slot.

In an example, the unit grid may have a square shape, and a length of one side of the unit grid may be substantially same as a half wavelength (2/λ) of the communication frequency.

In an example, the pattern portion may include at least one of a metal, a transparent conductive oxide, a transparent conductive polymer, and a carbon structure.

In an example, the unit grids may be spaced apart from each other, and the unit grids adjacent to each other may be connected with each other by a transparent electrode. In an example, an edge of the pattern portion may be formed with a first density, and a center of the pattern portion may be formed with a second density smaller than the first density.

In an example, an edge of the pattern portion may be formed with a first thickness, and a center of the pattern portion may be formed with a second thickness thinner than the first thickness.

In an example, the pattern portion may include a first pattern portion configured to transmit the communication frequency bands, and a second pattern portion configured to be heated.

In an example, a material of the first pattern portion may be different from that of the second pattern portion.

In an example, the first pattern portion may be disposed on a first area of the substrate, and the second pattern portion may be disposed on a second area of the substrate which is divided from the first area.

In an example, the cell may be asymmetrical with respect to an imaginary vertical axis that is perpendicularly orthogonal to a center of the cell.

In an example, an area of the slot formed at one unit grid of the plurality of the unit grids may be smaller that of the slot formed at the remaining unit grid of the plurality of the unit grids.

In an example, an area ratio of the slot in each cell may be 70% or more, when the pattern portion comprises an opaque material.

According to the present example embodiments, the pattern portion is formed to include cells that are asymmetrically formed based on a virtual vertical axis that is perpendicular to the center. Thus, the pattern portion may have an average transmission performance of more than 90% and visible light transmission performance of more than 70% in the 5G millimeter wave band of 27.5˜28.5 GHz. In addition, since the pattern portion may be heated and then fog, frost, etc. may be effectively removed, the pattern part may be used as a vehicle window.

The effects of the present invention are not limited to the effects described above, but should be understood to include all effects that can be inferred from the configuration of the invention described in the detailed description or claims of the present invention.

### BRIEF DESCRIPTION OF THE DRAWINGS

FIG. 1A and FIG. 1B are cross-sectional views each illustrating a structure according to an example embodiment of the present invention:

FIG. 2A, FIG. 2B, FIG. 2C and FIG. 2D are plan views each illustrating the structure of FIG. 1A and FIG. 1B:

FIG. 3A, FIG. 3B, FIG. 3C and FIG. 3D are graph showing transmittance performance of a pattern portion of FIG. 2A to FIG. 2D;

FIG. 4A is a plan view illustrating a pattern portion with a different slit direction of the structure and FIG. 4B is a graph showing transmittance performance of the pattern portion of FIG. 4A:

FIG. 5A is a plan view illustrating a pattern portion with an increased aperture ratio of the structure and FIG. 5B is a graph showing transmittance performance of the pattern portion of FIG. 5A:

FIG. 6A and FIG. 6B are plan views each illustrating a pattern portion with a different slit of the structure:

FIG. 7 is a plan view illustrating status of use of the structure of FIG. 1A and FIG. 1B:

FIG. 8 is a plan view illustrating a pattern portion of a structure according to another example embodiment of the present invention:

FIG. 9 is a plan view illustrating a pattern portion of a structure according to still another example embodiment of the present invention; and

FIG. 10 is a plan view illustrating a pattern portion of a structure according to still another example embodiment of the present invention.

### DETAILED DESCRIPTION

The invention is described more fully hereinafter with Reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, the invention is described more fully hereinafter with reference to the accompanying drawings, in which embodiments of the invention are shown.

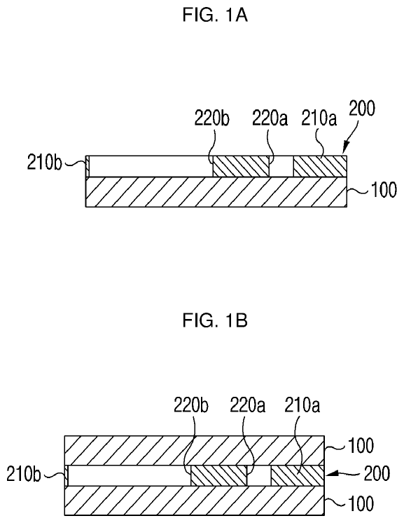

FIG. 1A and FIG. 1B are cross-sectional views each illustrating a structure according to an example embodiment of the present invention.

Referring to FIG. 1A and FIG. 1B, the structure includes a substrate 100 and a pattern portion 200.

The substrate 100 is transparent to visible light. The substrate 100 may include a glass, polycarbonate (PC), colorless polyimide (CPI), polyethylene terephthalate (PET) and so on. When the substrate 100 is applied to a vehicle, the substrate 100 may be a glass substrate for a vehicle window.

The pattern portion 200 is formed or disposed on the substrate 100. As illustrated in FIG. 1A, when the substrate 100 is a single layer, the pattern portion 200 may be disposed on the substrate 100. Alternatively, as illustrated in FIG. 1B, when the substrate 100 is a multi-layer stacked with each other, the pattern portion 200 may be disposed between the substrates 100 stacked with each other.

The pattern portion 200 transmits communication frequency bands, and thus, 5G high-speed communication may be stably performed at the vehicle in which the structure is equipped.

In addition, the pattern portion 200 may be heated, and thus, fogging and frosting of the structure may be effectively removed.

Hereinafter, the pattern portion 200 is explained in detail.

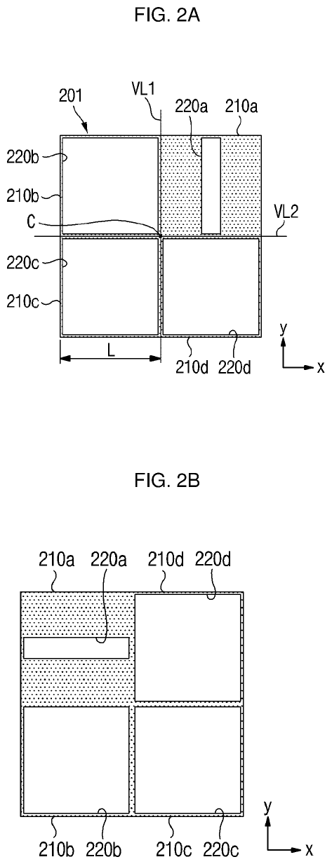

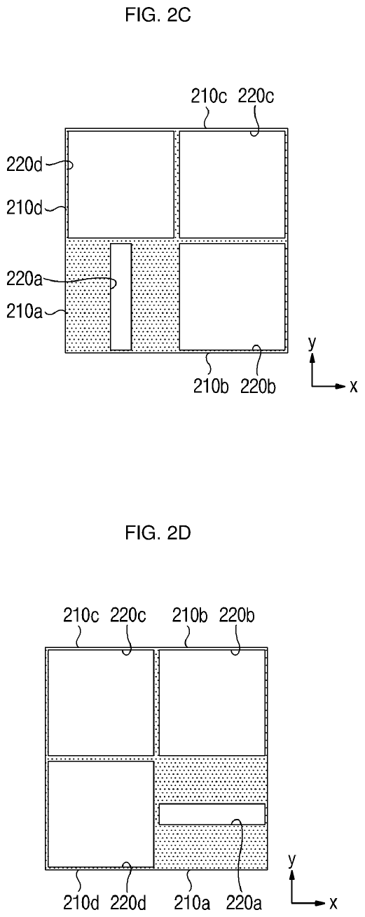

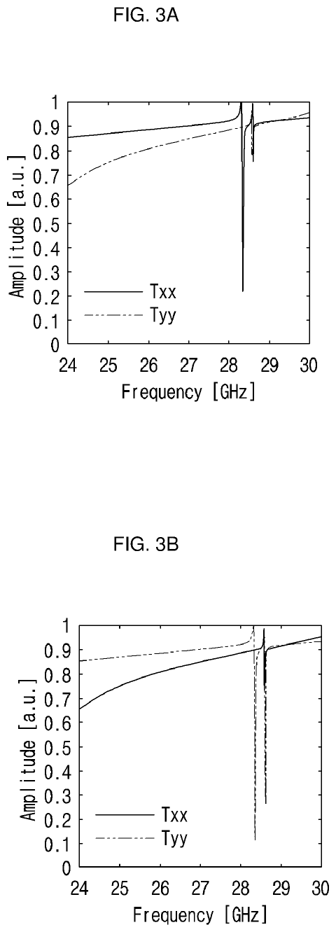

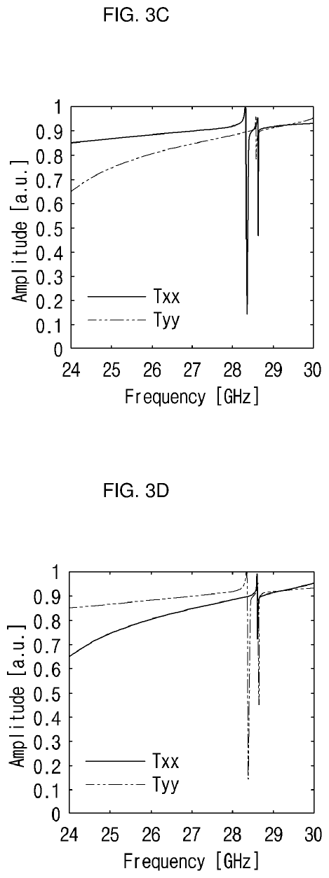

FIG. 2A, FIG. 2B, FIG. 2C and FIG. 2D are plan views each illustrating the structure of FIG. 1A and FIG. 1B. FIG. 3A, FIG. 3B, FIG. 3C and FIG. 3D are graph showing transmittance performance of a pattern portion of FIG. 2A to FIG. 2D.

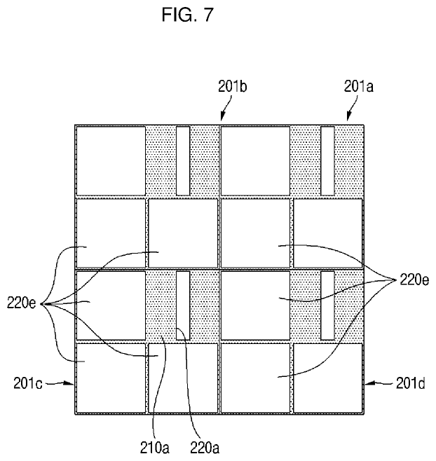

FIG. 2A to FIG. 2D shows a single cell 201, and the pattern portion 200 includes a plurality of the cells 201. The cell 201 is arranged along an X-axis direction and an Y-axis direction. The pattern portion 200 may be formed over an entire substrate 100 (referring to FIG. 7).

Referring to FIG. 2A, the cell 201 has a plurality of unit grids 210a, 210b, 210c and 210d. Each of the unit grids 210a, 210b, 210c and 210 is arranged along the X-axis direction and the Y-axis direction, and the unit grids 210a, 210b, 210c and 210 are formed to be 2*2 matrix shape in the cell 201.

A plurality of slots 220a, 220b, 220c and 220d is respectively formed at the plurality of the unit grids 210a, 210b, 210c and 210d. Each of the slots 220a, 220b, 220c and 220d passes through each of the unit grids 210a, 210b, 210c and 210d.

The pattern portion 200 may include at least one of a metal, a transparent conductive oxide, a transparent conductive polymer and a carbon structure. Here, the metal may include a metal thin film, a sliver nanowire, a copper nanowire and so on. The transparent conductive oxide may include ITO (indium tin oxide), AZO (aluminum-doped zinc oxide), FTO (fluorine-doped tin dioxide) and so on. The carbon structure may have a graphite phase or shape and may include graphene, CNT (carbon nanotube), fullerene and so on.

Each of the slots 220a, 220b, 220c and 220d is an opening area.

Hereinafter, for the convenience of explanation, in the cell 201, an upper right side is called as a first quadrant, an upper left side is called as a second quadrant, a lower left side is called as a third quadrant, and a lower right side is called as a fourth quadrant.

Each of the unit grids 210a, 210b, 210c and 210d is disposed at each of the first to fourth quadrant. Each of the unit grids 210a, 210b, 210c and 210d has a square shape, and a length L of one side of each of the unit grids 210a, 210b, 210c and 210d may be substantially same as a half wavelength (2/λ) of the communication frequency. Here, an incident communication frequency may be the 5G millimeter wave band of 27.5 to 28.5 GHz.

In addition, an area of the slot 220a formed in the unit grid 210a formed in one quadrant may be smaller than that of each of the slots 220b, 220c and 220d respectively formed in the unit grids 210b, 210c and 210d formed in the remaining quadrants.

Thus, the cell 201 may be asymmetrical with respect to an imaginary vertical axis VL1 and VL2 that is perpendicularly orthogonal to a center C of the cell.

Here, the unit grid 210a in which the slot 220a having a relatively small area is formed is not limited to being located in a specific quadrant.

FIG. 2B shows the cell 201 of FIG. 2A rotated counterclockwise by 90° with respect to the center C, FIG. 2C shows the cell 201 of FIG. 2B rotated counterclockwise by 90° with respect to the center C, FIG. 2D shows the cell 201 of FIG. 2C rotated counterclockwise by 90° with respect to the center C. Here, as illustrated in FIG. 2A to FIG. 2D, the unit grid 210a in which the slot 220a with a relatively small area is formed may be arranged without being limited to the specific quadrant.

FIG. 3A shows transmittance of the cell 201 of FIG. 2A, FIG. 3B shows transmittance of the cell of FIG. 2B, FIG. 3C shows transmittance of the cell of FIG. 2C, and FIG. 3D shows transmittance of the cell of FIG. 2D.

Referring to FIG. 2A and FIG. 2C, and FIG. 3A and FIG. 3C, when the slot 220a extends along the Y-axis direction, more than 90% of X polarization Txx is transmitted and more than 85% of Y polarization Tyy is transmitted in the 5G millimeter wave band of 27.5 to 28.5 GHz. Thus, it may be seen that an average of the X polarization Txx and the Y polarization Tyy may be more than 90%.

In addition, referring to FIG. 2B and FIG. 2D, and FIG. 3B and FIG. 3D, when the slot 220a extends along the X-axis direction, more than 90% of Y polarization Tyy is transmitted and more than 85% of X polarization Txx is transmitted in the 5G millimeter wave band of 27.5 to 28.5 GHz. Thus, it may be seen that an average of the X polarization Txx and the Y polarization Tyy may be more than 90%.

It may be seen that no matter which quadrant the smallest slot 220a is located in, on average, more than 90% is transmitted in the 5G millimeter wave band of 27.5 to 28.5 GHz.

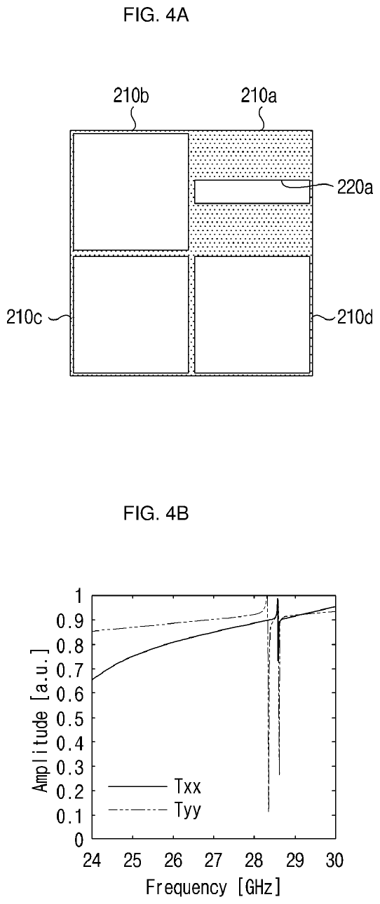

In addition, the shape of the relatively small slot 220a is also not specifically limited. FIG. 4A is a plan view illustrating a pattern portion with a different slit direction of the structure and FIG. 4B is a graph showing transmittance performance of the pattern portion of FIG. 4A. In FIG. 2A, the slot 220a of the unit grid 210a disposed in the first quadrant is formed to extend in the Y-axis direction, whereas in FIG. 4A, the slot 220a of the unit grid 210a disposed in the first quadrant is formed to extend in the X-axis direction. In this case, more than 90% of Y polarization Tyy is transmitted and more than 85% of X polarization Txx is transmitted in the 5G millimeter wave band of 27.5 to 28.5 GHz. Thus, it may be seen that an average of the X polarization Txx and the Y polarization Tyy may be more than 90%.

In the cell 201 of FIG. 2A to FIG. 2D, an area ratio of the slot, that is, an aperture ratio, is 72.6%. As the aperture ratio increases, the transmittance performance may be also improved.

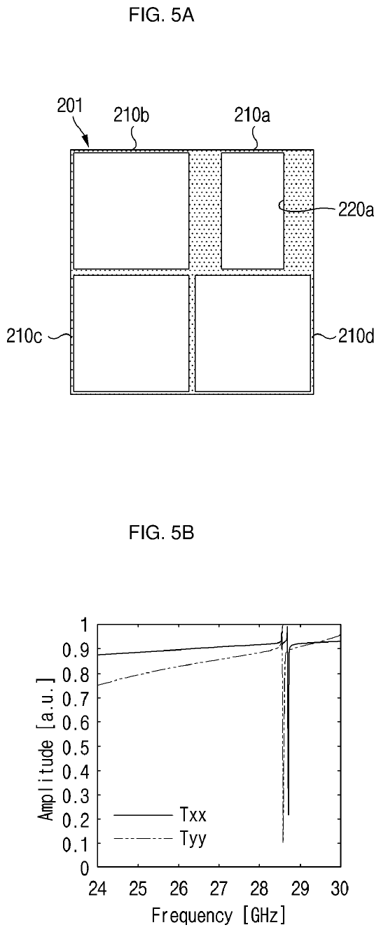

FIG. 5A is a plan view illustrating a pattern portion with an increased aperture ratio of the structure and FIG. 5B is a graph showing transmittance performance of the pattern portion of FIG. 5A. Here, in FIG. 5A, the aperture ratio of the cell 201 is 81.6%.

As illustrated in FIG. 5A and FIG. 5B, when a width of the smallest slot 220a increases and the aperture ratio increases, more than 90% of X polarization Txx is transmitted and more than 87% of Y polarization Tyy is transmitted in the 5G millimeter wave band of 27.5 to 28.5 GHz, and thus the average transmittance may be enhanced.

Total aperture ratio of the pattern portion may be more than 70%, in the cell 201. Then, even though the cell 201 includes an opaque metal material, the pattern portion 200 may have visible light transmittance of over 70% and the structure may be used for the vehicle window.

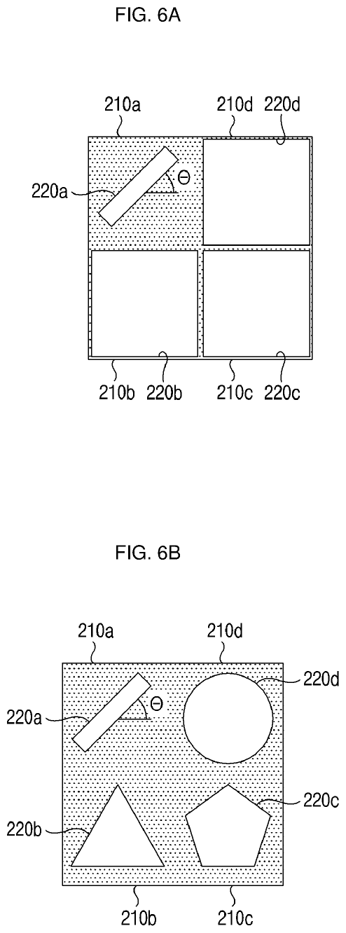

FIG. 6A and FIG. 6B are plan views each illustrating a pattern portion with a different slit of the structure.

As illustrated in FIG. 6A, the relatively smallest slot 220a is not limited to extending in the X-axis direction or the Y-axis direction as described above, but may be formed in a shape inclined by θ. Here, the difference between X polarization and Y polarization may be decreased. For example, when θ is 45°, the X polarization is substantially same as the Y polarization.

In addition, the remaining relatively large slots 220b, 220c, and 220d may be all formed in the same shape and size (referring to FIG. 6A), or the remaining relatively large slots 220b, 220c, and 220d may be formed in different shapes and sizes (referring to FIG. 6B).

FIG. 7 is a plan view illustrating status of use of the structure of FIG. 1A and FIG. 1B.

Referring to FIG. 7, the plurality of the cells 201a, 201b, 201c and 201d is adjacent to each other and is arranged to be connected with each other. In each of the cells 201a, 201b, 201c and 201d, the slot 220a, which are relatively the smallest in size, is arranged in the same position (the first quadrant based on FIG. 7). Thus, a slot 210e with a relatively large opening may be disposed around one slot 220a and the slots 210e surround the slot 220a.

In addition, the plurality of the cells 201a, 201b, 201c and 201d are arranged to be connected to each other, and thus all cells 201a, 201b, 201c and 201d may be heated when the current is applied to at least one of the cell 201a, 201b, 201c and 201d.

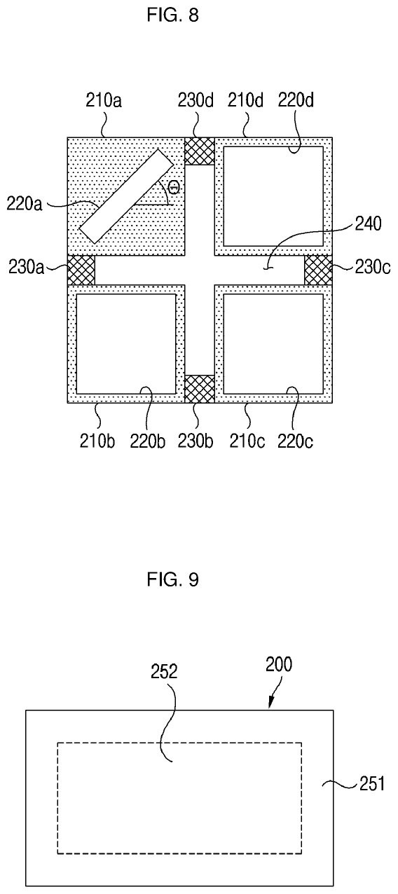

FIG. 8 is a plan view illustrating a pattern portion of a structure according to another example embodiment of the present invention.

Referring to FIG. 8, the plurality of the unit grids 210a, 210b, 210c and 210d is arranged to be spaced apart from each other. In addition, the pattern portion 200 may further include a plurality of transparent electrodes 230a, 230b, 230c and 230d, and the transparent electrode connects each spaced apart unit grid to each other.

To this end, each of the transparent electrodes 230a, 230b, 230c and 230d may be formed a space 240 which is formed between the unit grids adjacent to each other, and as illustrated in the figure, each transparent electrode is partially formed in the space 240.

The plurality of the unit grids 210a, 210b, 210c and 210d is spaced apart from each other, and thus the visible light transmittance may be more enhanced. In addition, the unit grids 210a, 210b, 210c and 210d are connected by the transparent electrodes 230a, 230b, 230c and 230d, and thus the heating may be more effectively performed when the current is applied.

FIG. 9 is a plan view illustrating a pattern portion of a structure according to still another example embodiment of the present invention.

Referring to FIG. 9, the pattern portion 200 is divided to be an edge 251 and a center 252. Here, the edge 251 may be an edge portion of the pattern portion 200, and the center 252 may be a central portion of the pattern portion 200.

An aperture ratio of the pattern portion 200 may be expressed as Equation (1), and a density of the pattern portion 200 may be expressed as Equation (2).

Aperture ratio (%)=(area of slot/area of substrate)*100 Equation (1)

Density (%)=(area occupied by pattern portion/area of substrate)*100 Equation (2)

Here, the edge 251 is formed as a first density, and the center 252 is formed as a second density smaller than the first density.

As explained above, total aperture ratio of the pattern portion 200 may be more than 70%. Assuming that the material forming the pattern portion 200 covers the entire substrate 100 without any gaps as 100%, the second density of the center 252 may be 30% or less, and the first density of the edge 251 may be 30% more. The density of the pattern portion 200 may be dense at the edge 251 and low at the center 252. Thus, relatively high visible light transmittance may be secured in the central portion of the structure, and safety may be ensured when the structure is applied as the vehicle window.

Alternatively, the edge 251 has a first thickness and the center 252 has a second thickness thinner than the first thickness. Thus, more uniform heating may be possible, and safety may be ensured when the structure is applied as the vehicle window.

The edge 251 and the center 252 are not limited to a specific location, shape, or area, and are relative concepts to each other. Then, the edge 251 and the center 252 may be appropriately defined depending on the area and shape of the structure.

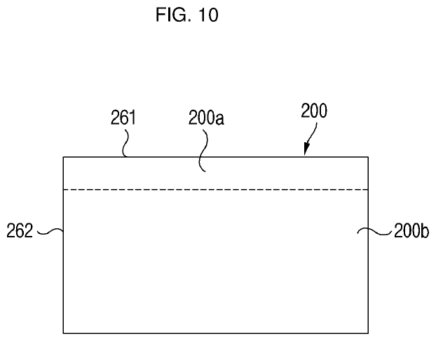

FIG. 10 is a plan view illustrating a pattern portion of a structure according to still another example embodiment of the present invention.

As illustrated in FIG. 10, the pattern portion 200 has a first pattern portion 200a and a second pattern portion 200b.

In addition, the first pattern portion 200a is formed in and on a first area 261 and the second pattern portion 200b is formed in and on a second area 262 divided from the first area 261.

In the present example embodiment, the first and second pattern portions 200a and 200b have functions different from each other. The first pattern portion 200a transmits the communication frequency bands, and the second pattern portion 200b is heated.

Considering the case when the structure is applied as the vehicle window, the first area 261 is preferably an upper area of the structure, so that the communication frequency band may be stably transmitted in the upper area of the structure.

In addition, the second area 262 is the remaining area of the structure and may be an area where the field of view of vehicle occupants, including the driver, mainly resides. Thus, the second area 262 may be a larger area than the first area 261, and may be heated to effectively remove fogging and frost, thereby ensuring visibility.

The first pattern portion 200a and the second pattern portion 200b may include the materials different from each other.

For example, in the case where the transmittance of the communication frequency bands is superior when the pattern portion is formed of a metal material rather than the pattern portion formed of graphene or ITO, the first pattern portion 200a may include the metal material and the second pattern portion 200a may include the transparent material such as graphene or ITO. Thus, the visible light transmittance may be enhanced.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

The present invention relates to the structure, and more specifically, to the transparent heating structure that transmits the 5G communication band, has high transmittance in the visible light band, is capable of heating, and transmits the communication frequency band.

What is claimed is:

1. A transparent heating structure comprising:
a substrate transparent to visible light; and
a pattern portion disposed on the substrate, and configured to transmit communication frequency bands and to be heated,
wherein the pattern portion has a plurality of cells disposed on the substrate,
wherein each of the cells has a plurality of unit grids having a slot.

2. The transparent heating structure of claim 1, wherein the unit grid has a square shape, and a length of one side of the unit grid is substantially same as a half wavelength (2/λ) of the communication frequency.

3. The transparent heating structure of claim 1, wherein the pattern portion comprises at least one of a metal, a transparent conductive oxide, a transparent conductive polymer, and a carbon structure.

4. The transparent heating structure of claim 1, wherein the unit grids are spaced apart from each other, and the unit grids adjacent to each other are connected with each other by a transparent electrode.

5. The transparent heating structure of claim 1, wherein an edge of the pattern portion is formed with a first density, and a center of the pattern portion is formed with a second density smaller than the first density.

6. The transparent heating structure of claim 1, wherein an edge of the pattern portion is formed with a first thickness, and a center of the pattern portion is formed with a second thickness thinner than the first thickness.

7. The transparent heating structure of claim 1, wherein the pattern portion comprises:
a first pattern portion configured to transmit the communication frequency bands; and
a second pattern portion configured to be heated.

8. The transparent heating structure of claim 7, wherein a material of the first pattern portion is different from that of the second pattern portion.

9. The transparent heating structure of claim 8, wherein the first pattern portion is disposed on a first area of the substrate, and the second pattern portion is disposed on a second area of the substrate which is divided from the first area.

10. The transparent heating structure of claim 1, wherein the cell is asymmetrical with respect to an imaginary vertical axis that is perpendicularly orthogonal to a center of the cell.

11. The transparent heating structure of claim 1, wherein an area of the slot formed at one unit grid of the plurality of the unit grids is smaller that of the slot formed at the remaining unit grid of the plurality of the unit grids.

12. The transparent heating structure of claim 1, wherein an area ratio of the slot in each cell is 70% or more, when the pattern portion comprises an opaque material.
